(19) United States
(12) Patent Application Publication
(10) Pub. No.: US 2006/0047822 A1
(43) Pub. Date: Mar. 2, 2006

(54) System and method for optimizing publication of operating states

(76) Inventor: Edward Dean Willis, Plano, TX (US)

Correspondence Address: BAKER BOTTS L.L.P., 2001 ROSS AVENUE, SUITE 600, DALLAS, TX, 75201-2980, US

(21) Appl. No.: 11/172,736

(22) Filed: Jun. 30, 2005

Related U.S. Application Data
(60) Provisional application No. 60/521,765, filed on Jun. 30, 2004.

(51) Int. Cl. G06F 15/16

(52) U.S. Cl. 709/228

(57) ABSTRACT

A system and method for optimizing publication operating states includes sending a first publication message to provide an operating state of a mobile unit. The operating state of the mobile unit is stored in a data session slot associated with the mobile unit. A second publication message is sent to update the operating state of the mobile unit. An entity tag value is derived from identifiers in accounting information of the second publication message to identify data in the data session slot associated with the mobile unit.

### RELATED APPLICATION

This application claims the benefit under 35 U.S.C. § 119(e) of U.S. Provisional Application Ser. No. 60/521,765 entitled: “Mechanism for Optimization of IS-835 Data Session State using SIP Events,” filed on Jun. 30, 2004 and incorporated by reference herein.

### TECHNICAL FIELD OF THE INVENTION

This invention relates generally to the field of communications and more specifically to a system and method for optimizing publication of operating states.

### BACKGROUND

Presence information may be published to a presence server. Entity tag values identify the data associated with a data session. The presence server includes data session slots that store data associated with a data session's operating state. Conventionally, publication messages related to the data session slot included an old entity tag value in the request and the new operating state. The presence server replaced the stored operating state with the new operating state and returned a new entity tag value associated with the new operating state. The new entity tag value was then used in the next publication message. Therefore, the entity tag value traditionally changed with every new publication of the operating state. An authentication, authorization, and accounting (AAA) server updated the stored entity tag value with each transaction. Therefore, the AAA server kept an entity tag value to identify the data content. If the AAA server was implemented as a redundant cluster, the entity tag value was stored in a persistent storage or communicated across all nodes in a cluster. Storing the entity tag value and/or communicating the entity tag value across all nodes in the cluster is an expensive task.

If the entity tag value identifying the data content in the data session slot was lost, new data session slots were allocated, which also caused the sequence of operating states to be lost. Allocating additional data session slots required additional storage capacity and composition logic in the presence server to compare the operating states in the different slots and determine what information to report to applications that subscribed to the operating state of the mobile unit. An increased workload consequently occurred on the presence server.

### SUMMARY OF THE DISCLOSURE

From the foregoing, it may be appreciated by those skilled in the art that a need has arisen for an improved system and method for publishing operating states. In accordance with the present invention, disadvantages and problems associated with conventional publication of operating states may be reduced or eliminated.

According to one embodiment of the invention, a system and method for optimizing publication of operating states includes sending a first publication message to provide an operating state of a mobile unit. The operating state of the mobile unit is stored in a data session slot associated with the mobile unit. A second publication message is sent to update the operating state of the mobile unit. An entity tag value is derived from identifiers in accounting information of the second publication message to identify data in the data session slot associated with the mobile unit.

Certain embodiments of the invention may provide one or more technical advantages. A technical advantage of one embodiment includes deriving an entity tag with an associated value that identifies a specific instance of data content of a data session. Providing for a derivation of the entity tag value allows for a determination without having to store the entity tag value.

Another technical advantage of another embodiment includes reducing the allocation of additional data session slots to store subsequent operating states if the entity tag value identifying the data in a previous state is lost. Operating states may be provided to applications without having to allocate additional data session slots if the entity tag value identifying the data content in a data session slot is lost.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, wherein like reference numerals represent like parts, in which:

FIG. 1 is a block diagram illustrating a communication system that provides operating states of mobile units;

FIG. 2 is a call-flow diagram illustrating an example of providing the operating state of a mobile unit using an AAA server;

FIG. 3 is a flowchart illustrating an example of providing the operating state of a mobile unit using an AAA server.

### DETAILED DESCRIPTION OF THE DRAWINGS

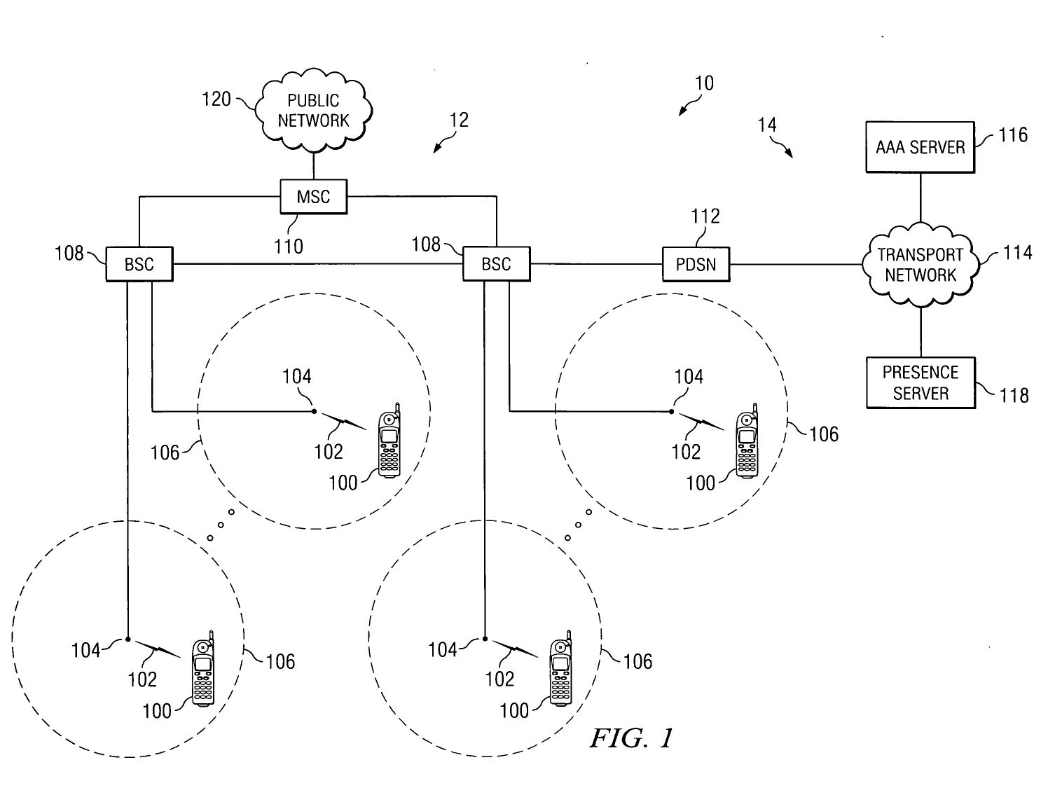

FIG. 1 illustrates a communication system 10 that provides operating states of mobile units 100. System 10 includes a wireless network 12 in which wireless transmissions of mobile unit 100 originate in geographically delimited cells. System 10 also includes a wireline network 14 in which the transmissions of mobile unit 100 are used to determine the operating state of mobile unit 100.

Wireless network 12 includes mobile units 100 that communicate information using a wireless link 102. Mobile units 100 may be cell phones, data phones, portable data devices, portable computers, handheld devices, handsets, or other suitable devices capable of communicating information over a wireless link 102.

Wireless link 102 may be a radio frequency (RF) link. The wireless link may be based on any suitable technology or standard, such as Code Division Multiple Access (CDMA) 2000 or GSM. In the illustrated embodiment, wireless link 102 comprises a CDMA link based on a CDMA standard. Wireless link 102 communicates the transmissions of mobile unit 100 to base transceiver station (BTS) 104.

BTSs 104 receive information destined for mobile unit 100 and wirelessly communicate the information to mobile unit 100 over wireless link 102. BTSs 104 each cover a geographic region, or cell 106, of wireless network 12 and communicate with mobile units 100 in cell 106. Each BTS 104 may wirelessly communicate with multiple mobile units located within its cell 106. BTS 104 includes a packet control function (PCF) to manage the sending and receiving of data to and/or from mobile unit 100. PCFs may be logic encoded in media, microcontrollers, application-specific integrated circuits, state machines, and/or any other type of device for manipulating information in a logical manner.

Base station controllers (BSC) 108 connect to BTS 106 and to each other. Wireless network 12 may include several BSCs 108. BSCs 108 connect to mobile switching center (MSC) 110. BSCs 108 and MSC 110 provide switch and soft handoff functionality for wireless network 12. In this way, information, such as voice, video, audio, text, and/or any other type of information, is routed to and from mobile units 100 and connections are maintained with mobile units 100 as they move throughout wireless network 12. MSC 110 is also able to perform authentication and set up and disconnect calls for mobile units 100 serviced by BTSs 104. MSC 110 communicates with a public network 120. Public network 120 may include any transport network 102 may include any combination of gateways, routers, hubs, switches, access points, base stations, and any other hardware and/or software that may implement any suitable protocol or communication.

Wireless network 12 connects to wireline network 14 through a packet data serving node (PDSN) 112. PDSN 112 includes a router that directs traffic between wireless network 12 and wireline network 14.

Wireline network 14 includes a transport network 114 that connects one or more servers to each other and to PDSN 112. In the illustrated embodiment, servers include an AAA server 116 and a presence server 118. Transport network 102 may include a public switched telephone network (PSTN), a local area network (LAN), a wide area network (WAN), any other public or private data network, a local, regional, or global communication network such as the Internet, an enterprise intranet, other suitable wireline communication link, or any combination of the preceding.

AAA server 116 gathers accounting information, planning information, and measurements reflecting the performance of system 10. Accounting information may refer to information used to assess a cost for the communication session. AAA server 116 may generate accounting records for the data session of mobile unit 100. The accounting records may be communicated to elements in system 10 through accounting information. AAA server 116 may operate with any suitable protocol.

Presence server 118 processes information to determine the state of mobile unit 100, such as presence information. Presence information may include any suitable information that describes the location of the relevant user, the availability of that user, the reachability of the user, and/or preferred modes of communication for the user for the purposes of communicating with other users. Examples of presence information include, but are not limited to, information indicating whether a user is currently logged into a particular network or component, information identifying a wireless network in which the user is currently located, information indicating whether the user has used a particular component of network 10 within a predetermined time period, information identifying an activity presently scheduled for the user, and information specifying a physical location of the user. Presence server 118 may operate with any suitable protocol.

In operation, when mobile unit 100 desires a data session, which may, for example, be triggered by the initiation of an application at mobile unit 100 and/or the activation of mobile unit 100, a data session is initiated between mobile unit 100, BTS 104, and a serving node. In the illustrated embodiment, the data session of mobile unit 100 is a wireless session. Establishing a data session may involve allocating RF resources between mobile unit 100 and serving BTS 104, allocating an IP address to mobile unit 100, and/or any other appropriate function. While mobile unit 100 is in operation, AAA server 116 may generate accounting information that includes the operating state of mobile unit 100. AAA server 116 reports the accounting information to presence server 118. AAA server 116 may use any suitable protocol to communicate with presence server 118, such as Session Initiation Protocol (SIP). If SIP is used, AAA server 116 provides the accounting information to presence server 118 using a PUBLISH message. The PUBLISH message may include a data element (an entity tag) with an associated value to identify a specific instance of data content stored in a data session slot of presence server 118.

In particular embodiments, presence server 118 derives the entity tag value associated with a PUBLISH message. The derivation of the entity tag value occurs when there is no entity tag value or an unrecognized entity tag value is within the PUBLISH message. Therefore, presence server 118 does not need to store the entity tag value or create a new data session slot to store the new operating state of mobile unit 100 if the entity tag value for a PUBLISH message is lost by AAA server 116.

Data contained in the accounting information may be used to derive the entity tag value. The accounting information includes a session identifier (session-ID) and a correlation identifier (correlation-ID). The session-ID uniquely identifies the data session, and the correlation-ID uniquely identifies the authorization operation granting permission to instantiate the data session. The session-ID and correlation-ID are used to construct the entity tag value. The session-ID and correlation-ID may occur in any suitable representation, such as each identifier represented in the accounting information by strings of up to eight characters in length. The entity tag value may be constructed using any suitable operation, such as concatenating the two strings.

Modifications, additions, or omissions may be made to system 10 without departing from the scope of the invention. For example, system 10 may include any suitable number of elements. Moreover, one or more functions performed by an element in system 10 may be implemented in whole or in part by other elements. For example, a single server may implement the functions of AAA server 116 and presence server 118. Any suitable logic comprising software, hardware, other logic, or any suitable combination of the preceding may perform the functions of any component in system 10.

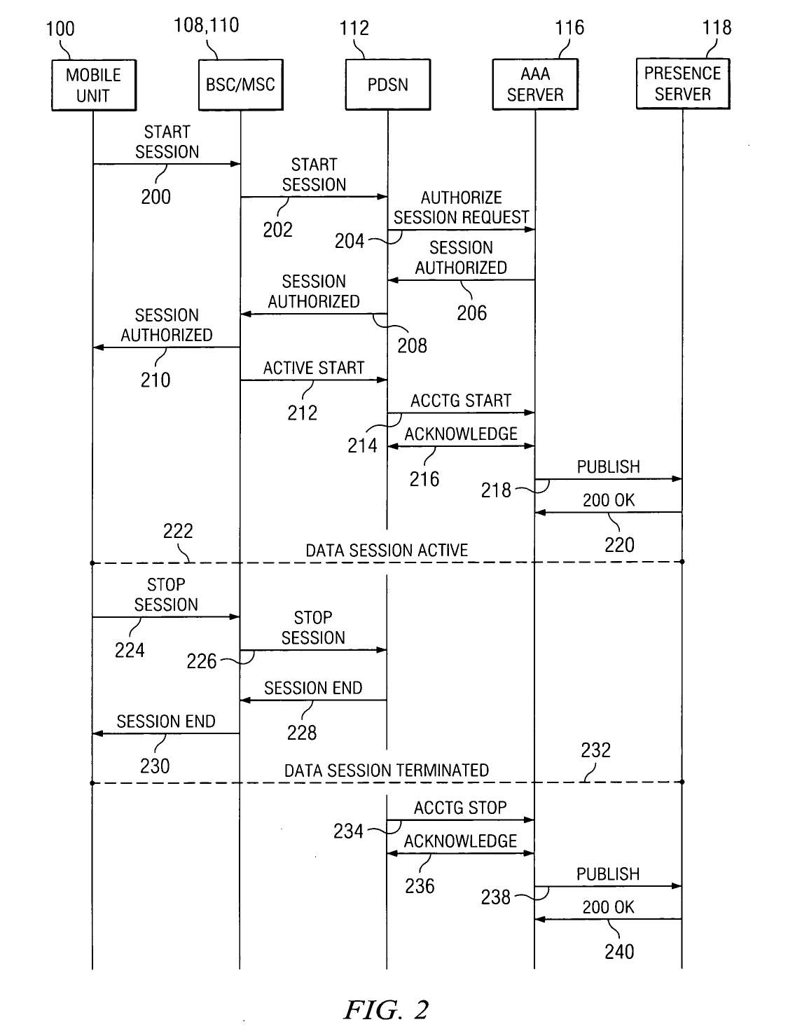

FIG. 2 is a call-flow diagram that illustrates providing the operating state of mobile unit 100 using AAA server 116. The call-flow diagram may use any suitable signaling protocol such as SIP to exchange messages.

Mobile unit 100 requests to establish a data session at message 200. BSC 108 and MSC 110 pass the start request to PDSN 112 at message 202. PDSN 112 requests authorization from AAA server 116 to authenticate and authorize the request for a data session at message 204. In the illustrated embodiment, AAA server 116 returns a positive authorization to PDSN 112 at message 206. In another embodiment, AAA server 116 may not authorize the request and the call-flow would subsequently terminate. The positive authorization propagates to BSC 108 and MSC 110 at message 208 and to mobile unit 100 at message 210. BSC 108 and MSC 110 send an airlink active start request to PDSN 112 at message 212. PDSN 112 sends an accounting start request to AAA server 116 at message 214. The accounting start request informs AAA server 116 to begin tracking the usage of mobile unit 100 and generating accounting information associated therewith. The accounting information may include the operating state of mobile unit 100. AAA server 116 acknowledges the accounting start request by sending an ACK to PDSN 112 at message 216.

AAA server 116 sends a PUBLISH message to presence server 118 at message 218. The PUBLISH message may include any suitable information, including the session-ID, the correlation-ID, and the operating state of mobile unit 100. In the illustrated embodiment, the PUBLISH message indicates that mobile unit 100 has an active data session in addition to other relevant information. The first PUBLISH message reporting the operating state of mobile unit 100 creates a new data session slot in presence server 118 that stores the operating state. The data session slot stores the operating state associated with mobile unit 100 for this particular data session in presence server 118.

Based on the information in the PUBLISH message, presence server 118 generates the entity tag value. Presence server 118 acknowledges the PUBLISH message by sending a 200OK to AAA server 116 at message 220. The 200OK includes an entity tag value identifying the data in the data session slot derived by presence server 118. The data session of mobile unit 100 is active at instance 222 and persists until termination.

At message 224, mobile unit 100 decides to terminate the data session and sends a termination request to BSC 108 and MSC 110. BSC 108 and MSC 110 send an airlink active stop request to PDSN 112 at message 226. PDSN 112 acknowledges the termination at message 228 and BSC 108 and MSC 110 acknowledge the termination at message 230. The data session ends and is terminated at instance 232.

The termination of the data session causes the operating state of mobile unit 100 to change. Therefore, PDSN 112 sends an accounting stop record to AAA server 116 at message 234. PDSN 112 acknowledges the accounting stop record at message 236. AAA server 116 sends a PUBLISH message indicating session termination to presence server 118 at message 238. In the illustrated embodiment, the PUBLISH message contains the entity tag value returned in message 220, which is from presence server 118 when the data session originally started. Presence server 118 tries to match this entity tag value with data in a data session slot. If presence server 118 finds a match, it stores the operating state into the identified data session slot and returns a 200OK to AAA server 116 at message 240. In another embodiment, if AAA server 116 does not have the entity tag value to identify the data, AAA server 116 may derive the entity tag value from the session-ID and the correlation-ID. Presence server 118 tries to match the derived entity tag value with data in a data session slot. In yet another embodiment, any suitable client may derive the entity tag value using the derivation techniques as described with respect to AAA server 116.

In other embodiments, if presence server 118 fails to match the entity tag value received in the PUBLISH message or if the PUBLISH message does not contain an entity tag value, presence server 118 may deduce the entity tag value using the session-ID and the correlation-ID in the accounting information. The operating state changes are stored in the data session slot corresponding to the entity tag value. By deducing the entity tag value from the session-ID and the correlation-ID, it may not be necessary to send the entity tag value to AAA server 116.

Particular embodiments provide entity tag values that remain invariant to new publications of states, even if the publication is updating the state of the continuing data session. Therefore, the number of persistent storage updates required to synchronize the entity tag values across nodes of a cluster of AAA servers 116 is reduced.

Modifications, additions, or omissions may be made to the call-flow diagram. For example, additional AAA servers may be included in system 10, which requires some communication between AAA server 116 and the additional AAA servers. For example, a mirroring operation may provide entity tag values to the additional AAA servers. As another example, the additional AAA servers may deduce the entity tag value without AAA server 116 performing a mirroring operation. In addition, messages may be performed in any suitable manner.

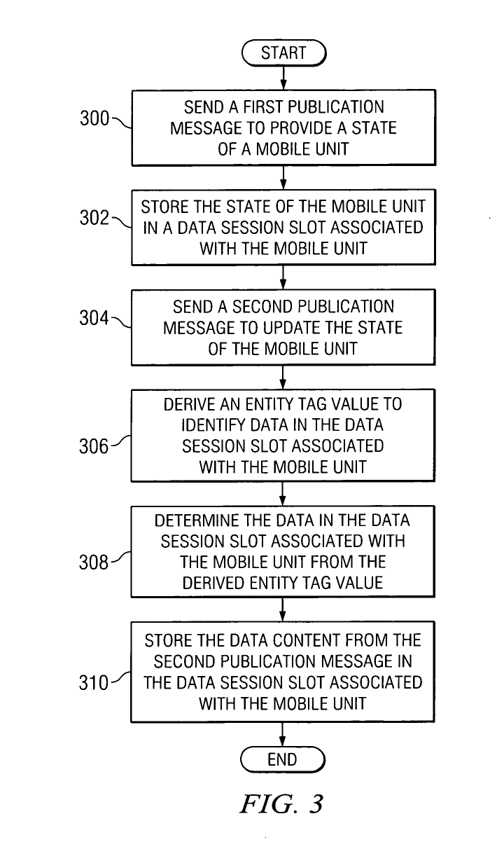

FIG. 3 is a flowchart illustrating an example of providing the operating state of mobile unit 100 using AAA server 116. AAA server 116 sends a first publication message to presence server 118 that includes the operating state of mobile unit 100 at step 300. The state's data content is stored in a data session slot in presence server 118 associated with mobile unit 100 at step 302. If the operating state of mobile unit 100 changes, AAA server 116 sends a second publication message to update the operating state of mobile unit 100 at step 304. An entity tag value is derived to identify the data in the data session slot at step 306. From the derived entity tag value, the data in the data session slot is determined at step 308. The operating state's data content from the second publication message is stored at step 310 in the data session slot associated with mobile unit 100.

Modifications, additions, or omissions may be made to the flowchart. For example, AAA server 116 may send any suitable number of publication messages to presence server 118 to update the operating state of mobile unit 100. Additionally, steps may be performed in any suitable manner.

While this disclosure has been described in terms of certain embodiments and generally associated methods, alterations and permutations of the embodiment and methods will be apparent to those skilled in the art. Accordingly, the above description of example embodiments does not constrain this disclosure. Other changes, substitutions, and alterations are also possible without departing from the scope and spirit of this disclosure.

What is claimed is:

1. A method for optimizing publication of operating states, comprising:
sending a first publication message to provide an operating state of a mobile unit;
storing the operating state of the mobile unit in a data session slot associated with the mobile unit;
sending a second publication message to update the operating state of the mobile unit;
deriving an entity tag value from identifiers in accounting information of the second publication message to identify data in the data session slot associated with the mobile unit.

2. The method of claim 1, wherein the identifiers in the accounting information include a session identifier and a correlation identifier of a data session.

3. The method of claim 2, wherein deriving the entity tag value includes concatenating the session identifier and the correlation identifier.

4. The method of claim 1, further comprising:
determining the data in the data session slot associated with the mobile unit using the derived entity tag value;
storing the operating state provided in the second publication message in the data session slot associated with the mobile unit.

5. The method of claim 1, further comprising keeping the derived entity tag value constant over a sequence of publication messages that identify an update of the operating state of the mobile unit.

6. The method of claim 5, further comprising determining the entity tag value to apply to a publication message if results of a sequence of publication messages are not tracked.

7. The method of claim 5, further comprising allowing for a determination of the data in the data session slot by deducing the entity tag value if results of the sequence of publication messages are not tracked.

8. A system for optimizing publication of operating states, comprising:
a plurality of mobile units operable to provide state information over a wireless network to a wireline network;
an authentication, authorization, and accounting (AAA) server within the wireline network operable to:
send a first publication message to provide an operating state of a mobile unit;
store the operating state of the mobile unit in a data session slot associated with the mobile unit;
send a second publication message to update the operating state of the mobile unit;
derive an entity tag value from identifiers in accounting information of the second publication message to identify data in the data session slot associated with the mobile unit.

9. The system of claim 8, wherein the identifiers in the accounting information include a session identifier and a correlation identifier of a data session.

10. The system of claim 9, wherein the AAA server is operable to concatenate the session identifier and the correlation identifier.

11. The system of claim 8, further comprising a presence server operable to:
determine the data in the data session slot associated with the mobile unit using the derived entity tag value;
store the operating state provided in the second publication message in the data session slot associated with the mobile unit.

12. The system of claim 8, further comprising a presence server operable to derive the entity tag value from identifiers in the accounting information of the second publication message to identify data in the data session slot associated with the mobile unit.

13. The system of claim 8, further comprising a presence server operable to:
receive the operating state provided in the second publication message;
store the operating state in the data session slot associated with the mobile unit.

14. The system of claim 8, wherein the AAA server is operable to keep the derived entity tag value constant over a sequence of publication messages that identify an update of the operating state of the mobile unit during a data session.

15. The system of claim 14, wherein the AAA server is operable to determine the entity tag value to apply to a publication message if results of a sequence of publication message are not tracked.

16. The system of claim 14, wherein a second AAA server is operable to deduce the entity tag value if results of the sequence of publication messages are not tracked.

17. A computer readable medium including logic for optimizing publication of operating states, the logic operable to:
send a first publication message to provide an operating state of a mobile unit;
store the operating state of the mobile unit in a data session slot associated with the mobile unit;
send a second publication message to update the state of the mobile unit;
derive an entity tag value from identifiers in accounting information of the second publication message to identify data in the data session slot associated with the mobile unit.

18. The computer readable medium of claim 17, wherein the identifiers in the accounting information include a session identifier and a correlation identifier of a data session.

19. The computer readable medium of claim 18, the logic operable to derive the entity tag value includes concatenating the session identifier and the correlation identifier.

20. The computer readable medium of claim 17, the logic operable to:
determine the data in the data session slot associated with the mobile unit using the derived entity tag value;
store the operating state provided in the second publication message in the data session slot associated with the mobile unit.

21. The computer readable medium of claim 17, the logic further operable to keep the derived entity tag value constant over a sequence of publication messages that identify an update of the state of the mobile unit.

22. The computer readable medium of claim 21, the logic further operable to determine the entity tag value to apply to a publication message if results of a sequence of publication messages are not tracked.

23. The computer readable medium of claim 21, the logic further operable to allow for a determination of the data in the data session slot by deducing the entity tag value if results of the sequence of publication messages are not tracked.

24. A system for optimizing publication of operating states, comprising:
means for sending a first publication message to provide an operating state of a mobile unit;
means for storing the operating state of the mobile unit in a data session slot associated with the mobile unit;
means for sending a second publication message to update the operating state of the mobile unit;
means for deriving an entity tag value from identifiers in accounting information of the second publication message to identify data in the data session slot associated with the mobile unit.
